(19) United States
(12) Patent Application Publication
(10) Pub. No.: US 2011/0131054 A1
(43) Pub. Date: Jun. 2, 2011

(54) Facility Disease or Infection Control Method, System and Apparatus

(76) Inventor: Daniel Theobald, Sommerville, MA (US)

(21) Appl. No.: 12/626,964

(22) Filed: Nov. 30, 2009

(51) Int. Cl. G06Q 50/00; G06Q 10/00; G06K 7/00

(52) U.S. Cl. 705/2; 235/375

(57) ABSTRACT

A method for providing disease or infection control at a facility including providing a user input device for access by a user as the user enters the facility, inputting at least one item of information into a system by the user via the user input device, and utilizing the at least one item of information to assist in determining whether the user should be attended to at the facility to at least reduce the chance of an infection being introduced into the facility, transmitted to others at the facility or having the user exposed to an infection or disease at the facility.

### BACKGROUND OF THE INVENTION

The present invention relates generally to disease or infection control, and more particularly to a method, system and apparatus for use at a facility, such as a medical facility, for example, having a number of features that enable various steps to be taken to reduce potential disease outbreaks at the facility and provide quality, timely treatment.

### SUMMARY OF THE INVENTION

A method for providing disease or infection control at a facility including providing a user input device for access by a user as the user enters the facility, inputting at least one item of information into a system by the user via the user input device, and utilizing the at least one item of information to assist in determining whether the user should be attended to at the facility to at least reduce the chance of an infection being introduced into the facility, transmitted to others at the facility or having the user exposed to an infection or disease at the facility.

### DESCRIPTION OF THE DRAWINGS

The following detailed description will be better understood when read in conjunction with the appended drawings, in which there is shown one or more of the multiple embodiments of the present disclosure. It should be understood, however, that the various embodiments of the present disclosure are not limited to the precise arrangements and instrumentalities shown in the drawings.

FIG. 1 is a perspective view illustrating one embodiment of a user input device of the present invention;

FIG. 2 illustrates a general layout of a facility that may utilize the teachings of the present invention; and

FIG. 3 is a perspective view illustrating another embodiment of a user input device of the present invention.

### DESCRIPTION OF THE PREFERRED EMBODIMENTS

The present invention will be described in detail with reference to embodiments that represent examples of the present invention and are not intended to limit the scope of the invention. Although specific elements and configurations are described to provide an understanding of the invention, it is to be understood that the specific embodiments, elements and configurations provided are for illustrative purposes only. Other configurations will be recognized by those of ordinary skill in the art without departing from the teachings of the present invention or the scope of the appended claims.

Various facilities and organizations require the presence of an individual, such as a customer, patient or the like, at the facility to obtain goods or services at the facility. Some examples of such facilities include, but are not limited to, a doctor's office, a medical clinic, a hospital, a bank, airline terminal, will-call desk, store, automotive service center, restaurant, school, military base or any other type of facility. It is to be understood that the particular facility itself can vary without departing from the teachings of the present invention.

A growing and important concern for any facility is the potential for an outbreak of some type of infection, virus, disease or the like that could find its way into the facility by a person visiting the facility and find a welcome environment for spreading within the facility as well as outside the facility. This is a particular concern lately in view of the H1N1 or “swine flue” pandemic that has spread across the world primarily due to human interactions.

Such outbreaks are of increased importance with hospital-acquired infections (HAI's) or nosocomial infections that result in substantial morbidity, mortality and waste of medical resources. Estimates from the Centers for Disease Control and Prevention (“CDC”) from 1992 suggest that between 2,000,000-5,000,000 patients acquire a nosocomial infection each year at a total cost of more than $4.5 billion. In 19,000 instances these infections were directly responsible for patient death and in 58,000 instances the infections were indirectly responsible for patient death. The CDC also estimates that about one-third of all HAI's can be avoided by appropriate infection control practices.

To reduce the impact of such outbreaks in a facility, a multi-faceted approach typically must be implemented in an attempt to control and reduce such outbreaks as much as possible. Such approaches typically include awareness and treatment with little if any care taken with regard to preventive measures.

The present invention provides at least one such preventive measure by providing a form of initial screening of customers or patients that visit a facility. Such screenings not only provide a potential notice to the facility, but provides a potential notice to the customer or patient who may be unaware or under-informed with regard to any potential disease or the like that the patient may have been exposed to or in fact be carrying.

It readily can be understood that measures that are employed at any facility to limit the number of potential infections that enter or disseminate within a facility represent a first efficient step in disease reduction or prevention. When such measures do not exist, on the other hand, not only are more and more people exposed but the costs to deal with the outbreaks rises significantly.

As an example, when an infection or disease enters a facility it may be days or even weeks until the infection or disease is identified. To reduce further spread of the infection or disease, portions of the facility or in some cases the entire facility itself along with all the potentially infected equipment in the facility must be thoroughly cleaned with a disinfectant, among other measures.

In an open facility where even minimal information might be available on where a particular person may or may not visited in the facility, the entire facility typically must be cleaned to eliminate the outbreak. In facilities where access is even minimally restricted or minimal, non-invasive tracking of individuals is provided cleaning may be limited to only portions of the facility thereby significantly reducing costs.

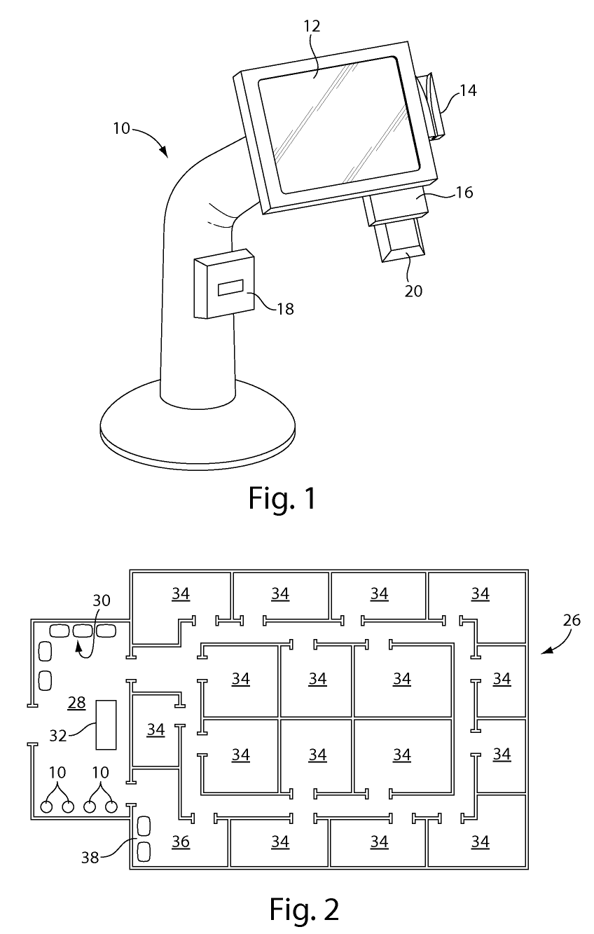

As FIG. 1 illustrates, one embodiment of a user input device of the present invention is generally illustrated with the reference numeral 10. In this embodiment, the device 10 is generally illustrated as a kiosk. It is to be understood, however, that the particular input device 10 may vary and may include a hand-held or any other type of device (not illustrated) and may be a stand-alone device or may be hardwired or wirelessly connected to other equipment if desired.

When the input device 10 is a kiosk, such as in FIG. 1, the kiosk may include a screen 12 and a number of peripheral devices such as a card swipe member 14, a scanner 16 and a dispensing member 18. It is to be understood, however, that the particular shape, size and design of the kiosk as well as the number and type of peripherals that may be included with the kiosk may vary.

It readily can be understood that when the input device 10 is in the form of a hand-held type device, most if not all of the features and peripherals identified with respect to a kiosk as illustrated in FIG. 1 can be included with the hand-held device. The hand-held device can be in the form of a laptop, an application specific type of hand-held member or a commercially available hand-held member such as a cell phone or similar type of device.

If desired, the input device 10 can include various methods for preventing or reducing the chance of some type of disease or infection spreading, including an antimicrobial coating or the like, for example. Such a coating can be included on various components of the input device 10 including the screen 12, card swipe member 14, scanner 16, and dispensing member 18 or any other component or structure of the input device 10.

The screen 12 provides the user with one or more information screens that provide information to the user and may be a touch screen if desired. The particular size, type and shape of the screen 12, however, can vary.

The card swipe member 14 enables some type of card having a magnetic stripe, chip or other type of information conveying member connected thereto. The particular size, type and shape of the card swipe member 14, however, can vary.

The scanner 16 enables information from a document or card to be scanned into the input device 10 to provide one or more items of information. In addition, the scanner 16 may include a tray or other position member 20 that is designed to position the document or card in the appropriate position for reading by the scanner 16. As with other members, the particular size, type and shape of the scanner 16 and tray 20 can vary.

The dispensing member 18 can be any type of printer or dispensing mechanism, for example, that can print out a variety of information on paper or a card or some type of ticket that may include a magnetic stripe or chip, including an RFID or similar type of device, to provide information for use at the facility. The magnetic stripe or chip can be programmed or activated by the dispensing member 18 or by the card swipe member 14 by a user after removing the paper or card from the dispensing member 18, if desired.

The stripe or chip may also be used to track a patient or customer as he/she makes their way through the facility and may be capable of providing directions to the patient or customer to lead them to the appropriate place in the facility. The item provided by the dispensing member 18 also can enable or restrict access to various areas of the facility 26, if desired.

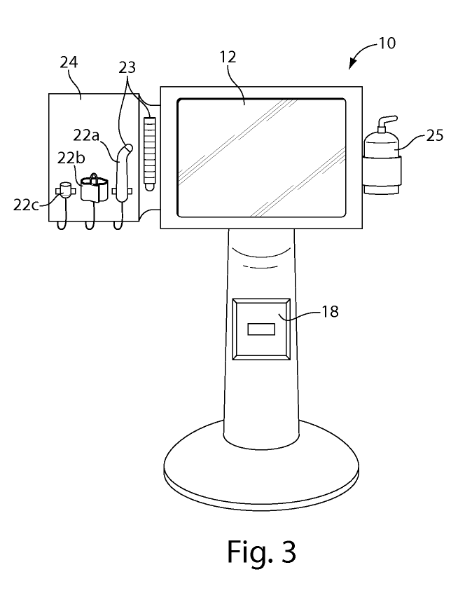

FIG. 3 illustrates another embodiment of the user input device 10 in the form of a kiosk having one or more additional peripheral devices generally illustrated with the reference numeral 22. The peripherals may include, for example, a thermometer 22a, a blood pressure cuff 22b, and a pulse meter 22c. The type, style, and number of peripheral devices 22 can vary and disposable cups or covers 23 can be included in a dispensing member if desired.

The input device 10 can also include a number of flexibly mounted privacy panels 24 that can be configured by a user to provide privacy with regard to information being displayed or entered on the screen 12. Although only one panel 24 is illustrated, panels can also be provided on the top and both sides of the screen 12 for added privacy. The panels 24 also can be manipulated to fold on top of the screen 12 (not illustrated) to protect the screen 12 when not in use and/or during transport or storage.

In addition, the input device 10 can include a dispenser 25 for a sanitizer member or holder for a sanitizing liquid or spray to sanitize the user or screen 12 and any other portion or peripheral of the device 10.

The input device 10 can be designed as a completely self contained unit, including any necessary electronics and software, that provides all of the features of the present invention without the need to interact with any other device. Alternatively, the input device 10 can be connected to other equipment, such as other computers or similar equipment, and can be connected to the other equipment either wirelessly or hard wired.

FIG. 2 illustrates one facility 26 that may utilize the teachings of the present invention. The facility 26 here is illustrated as a medical office or clinic, but it is to be understood that the particular facility 26 as well as the layout, services, equipment and other details of the facility 26 may vary without departing from the teachings of the present invention.

The facility 26 typically includes a check-in, reception or security area 28 that serves as the point of entry for a patient. The check-in area 28 typically includes a seating area 30, a check-in, reception or security desk or counter 32 and one or more user input devices 10. Of course the layout of the check-in area 28 and the number of input devices 10 and seats in the seating area 30 can vary.

The facility 26 typically includes a number of interior rooms 34 positioned about the floor of the facility 26. Although one floor of the facility 26 is illustrated, any number of floors or wings of the facility 26 may exist.

The rooms 34 can provide any number of functions to the facility 26, including exam rooms, offices, treatment rooms, labs, administrative items, x-ray, blood test or any other type of conceivable function. In addition, the rooms 34 can include any number and type of equipment that typically is found in a medical facility.

For reasons described in more detail below, in the present invention it may be preferable to include a screening or initial isolation room or area 36 where suspect patients may initially be directed from the check-in area 28. The screening room 36 may include a seating area 38 and may be attended by a staff member (not illustrated) of the facility 26.

Once in the screening area 36 additional information can be gathered to determine the state of the customer or patient while preventing the rampant spread of any particular disease or infection to other areas of the facility or exposing other customers, patients or personnel. If desired, the facility 26 can be designed to provide at least two distinctive treatment paths isolated from each other (not illustrated).

For example, one path may be for those potentially susceptible to diseases such as asthma or the like and include a series of examination and treatment rooms used only by such customers or patients. Alternatively, a separate treatment path may exist for those that may potentially be carrying some type of infection or disease to isolate them from others at the facility. This is of particular concern with flu pandemics that are recently being identified throughout the world.

Briefly, in use, the input device 10 obtains one or more items of information that could indicate a concern with regard to a customer or patient. The concern may vary, but typically may include a vital sign provided by one of the peripheral devices 22, a potential exposure to one or more diseases, or a particular susceptibility, among other concerns.

For example, if a high temperature is indicated by the thermometer 22a there may be a concern that the customer or patient has a condition that may require immediate treatment and/or some type of disease or infection that should be isolated. As another example, a concern may be identified based on recent travels of the customer or patient particularly to geographical areas that may currently have some type of disease associated with that area.

Various other questions posed by the input device 10 to the customer or patient can also raise a concern, such as the reason for the visit to the facility 26 or the current medical or other condition of the customer or patient among other questions. If an ID card is utilized with the input device 10, the card swipe member 14 can identify the customer or patient and, by integrating with various databases, determine any conditions the customer or patient may be susceptible to whether the customer or patient is a member of a high risk group.

For example, suppose a particular customer or patient has a medical condition such as asthma. During flu season, such customers or patients may have a higher susceptibility for contracting a virus or the like that may be present at the facility 26. If so, such customer or patient may want to be segregated or provided with some type of protection, such as a mask or the like to assist in preventing exposure while at the facility 26.

The input device 10 and associated electronics can be updated in real time not just with information from the particular facility 26 but with information from national and international sources. For example, if the facility 26 itself has reason to believe some type of infection or disease may be present in the facility 26 it may be desirable to isolate at least people that may be more susceptible to such infections or diseases.

Similarly, if a local, state, federal or international authority has reason to believe some type of infection or disease should be at least monitored, the input device 10 can be notified and modified to look for potential carriers or susceptible patients. For example, additional questions may be asked or current questions may be modified and presented to the user by the input device 10 in real time to help identify potential problems and develop courses of action. This may be particularly true in emergency situations where any number of issues may arise whether they be part of a natural or man-made disaster.

The information gathered may relate to a previous visit of the customer or patient to the facility where the customer of patient was exposed to or contracted a disease or infection from the facility. This is vitally important with regard to hospital acquired infections since prior strains can tend to become more and more difficult to treat as they mutate. In such instances, the current state of the patient may be vital information necessary to control additional outbreaks at the facility.

It readily can be appreciated that the first step in infection and disease control would be to limit any facility to the number of exposures. By merely cutting down on such exposure significant cost savings can be achieved in not only treatment but in cleaning of the facilities as well as potential legal awards.

The input device 10 also serves as a point of information gathering for health authorities. This information can be quite important to identify outbreaks and implement appropriate control and treatment procedures while providing an early notice to suppliers and shippers of particular drugs or the like that may need to be provided in a particular area in the case of a disaster or pandemic.

Currently, such information is not gathered let alone provided in substantially real-time to health care agencies responsible for local or national health care. When a customer enters a facility, no information about the potential state of health of the customer is gathered.

In a medical facility, patients are typically only asked for the reason for the visit by an administrative person at the facility. The patient is then asked to wait in a first waiting room along with all other patients at the facility before the patient is then escorted to an examination room.

Since inquiries with regard to potential symptoms or the like are not even made to the patient until they are in the examination room, a patient carrying a disease or infection can readily spread that disease or infection throughout the waiting area, any rest room, as well as the hallway between the waiting room and examination room. This would include potentially spreading the disease or infection to those sitting in the waiting room which could cause concern for those waiting.

More importantly, even if inquiries are made in the examination room the information gathered is contained within the individual patient record even if captured in an electronic medium. Due to the strict privacy laws in place with regard to that information, sharing of important information outside of the system of the facility rarely if ever takes place and can only be provided by a system that is approved, such as the system of the present invention.

It readily can appreciated that various facilities can benefit from the teachings of the present invention including various transportation systems, such as air, rail and bus, as well as government institutions, colleges, prisons, military bases, public events, and non-human areas such as veterinary facilities or the like just to name a few. Since the information can be limited and kept private, the system can be minimally invasive while providing an important screening not just for individuals already at the facility but to help with the particular individual checking into the facility.

The embodiments of the present disclosure may be implemented with any combination of hardware and software. If implemented as a computer-implemented apparatus, the embodiments of the present disclosure are implemented using means for performing all of the steps and functions described above.

The embodiments of the present disclosure can be included in an article of manufacture (e.g., one or more computer program products) having, for instance, computer useable media. The media has embodied therein, for example, computer readable program code means for providing and facilitating the mechanisms of the embodiments of the present disclosure. The article of manufacture can be included as part of a computer system or sold separately.

Although the description above contains many specific examples, these should not be construed as limiting the scope of the embodiments of the present disclosure but as merely providing illustrations of some of the presently preferred embodiments of this disclosure. Thus, the scope of the embodiments of the disclosure should be determined by the appended claims and their legal equivalents, rather than by the examples given.

It will be appreciated by those skilled in the art that changes could be made to the embodiments described above without departing from the broad inventive concept thereof. It is understood, therefore, that this disclosure is not limited to the particular embodiments disclosed, but it is intended to cover modifications within the spirit and scope of the embodiments of the present disclosure.

We claim:

1. A method for providing disease or infection control at a facility, comprising:
providing a user input device for access by a user as the user enters the facility;
inputting at least one item of information into a system by the user via the user input device; and
utilizing the at least one item of information to assist in determining whether the user should be attended to at the facility to at least reduce the chance of an infection or disease being introduced into the facility transmitted to others at the facility or having the user exposed to an infection or disease at the facility.

2. The method as defined in claim 1, wherein the user is immediately segregated at the facility based on the item of information.

3. The method as defined in claim 1, wherein the item of information includes a symptom of one or more infections or diseases.

4. The method as defined in claim 1, wherein the item of information relates to one or more locations the user has visited within a prior predetermined time frame.

5. The method as defined in claim 1, wherein the item of information relates to recent travel undertaken by the user.

6. The method as defined in claim 1, wherein the item of information identifies the user.

7. The method as defined in claim 1, wherein the user input device is a self-service kiosk.

8. The method as defined in claim 1, wherein the facility is a medical facility and the input device is a self-service kiosk.

9. The method as defined in claim 1, wherein the user input device is a hand-held device.

10. The method as defined in claim 1, including communicating information to at least one of local, state, regional, national or international agencies to at least monitor potential disease or infection concerns.

11. The method as defined in claim 10, including communicating the information in real time and providing additional questions or modifying existing questions to the user.

12. A user input device for providing disease or infection control at a facility, comprising:
a user input mechanism for access by a user as the user enters the facility to enable the user to input at least one item of information;
a processing device for receiving the at least one item of information, determining any relevance of the at least one item of information and communicating an alert signal when appropriate; and
a notification interface for receiving the alert signal and for providing a notice sufficient to cause the user to be attended to at the facility to at least reduce the chance of an infection or disease being introduced into the facility, transmitted to others at the facility or having the user exposed to an infection or disease at the facility.

13. The user input device as defined in claim 12, wherein the input device is a self-service kiosk.

14. The user input device as defined in claim 12, wherein the input device is a hand-held device.

15. The user input device as defined in claim 12, wherein the notice is provided to a person associated with the facility.

16. The user input device as defined in claim 12, wherein the notice is provided to the user and includes instructions to the user including directing the user to a next step at the facility.

17. The user input device as defined in claim 12, including a dispensing mechanism for providing the user with an item to take away from the input device that assists the user in determining the next step at the facility.

18. The user input device as defined in claim 17, wherein the item enables at least tracking of the user throughout the facility.

19. The user input device as defined in claim 17, wherein the item is capable of directing the user as the user makes his/her way through the facility.

20. The user input device as defined in claim 12, wherein the at least one item of information is a vital sign of the user that can be inputted at the device.

21. The user input devices as defined in claim 12, wherein the input mechanism is capable of reading information from an item provided by the user to the user input mechanism.

22. The user input devices as defined in claim 12, including an information communication mechanism to provide information to at least one of local, state, regional, national or international agencies to at least monitor potential disease or infection concerns.

23. The user input device as defined in claim 22, including communicating the information in real time and wherein the communication mechanism provides additional questions or modifying existing questions to the user

24. A system for providing disease or infection control at a facility, comprising:
user input means for access by a user as the user enters the facility to enable the user to input at least one item of information;
means for receiving and processing the at least one item of information, for determining any relevance of the at least one item of information and for communicating an alert signal when appropriate; and
notification means for receiving the alert signal and for providing a notice sufficient to cause the user to be attended to at the facility to at least reduce the chance of an infection or disease being introduced into the facility, transmitted to others at the facility or having the user exposed to an infection or disease at the facility.

25. The system as defined in claim 24, including an information communication mechanism to provide information to at least one of local, state, regional, national or international agencies to at least monitor potential disease or infection concerns.

26. The system as defined in claim 25, including communicating the information in real time and wherein the communication mechanism provides additional questions or modifying existing questions to the user.
